(19) United States
(12) Patent Application Publication
(10) Pub. No.: US 2006/0023083 A1
(43) Pub. Date: Feb. 2, 2006

(54) Method of controlling digital photographing apparatus for efficient reproduction operation and digital photographing apparatus adopting the same

(75) Inventor: Hyun-soo Yoo, Seongnam-si (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 10/966,521

(22) Filed: Oct. 15, 2004

(30) Foreign Application Priority Data
Jul. 27, 2004 (KR) 2004-58796

(51) Int. Cl. H04N 5/76

(52) U.S. Cl. 348/231.99

(57) ABSTRACT

A method of controlling a digital photographing apparatus in a moving-image photographing mode is provided. The method includes creating a moving-image file in a storage medium, storing moving-image data in the moving-image file, and reproducing the moving-image data stored in the moving-image file when in a reproducing mode. The method further includes the operations of storing frame data of the moving-image data in the moving-image file as still-image data when in the moving-image photographing mode and displaying a still image of the frame data stored in the moving-image file as a representative image of the moving-image file when in the reproducing mode.

This application claims the priority of Korean Patent Application No. 2004-58796, filed on Jul. 27, 2004, in the Korean Intellectual Property Office, the disclosure of which is incorporated herein in its entirety by reference.

### BACKGROUND OF THE INVENTION

1. Field of the Invention

The present invention relates to a method of controlling a digital photographing apparatus and a digital photographing apparatus using the same, and more particularly, to a method of controlling a digital photographing apparatus, which, in a moving-image photographing mode, creates a moving-image file in a storage medium and, when in a reproducing mode, reproduces moving-image data stored in the moving-image file, and a digital photographing apparatus using the same.

2. Description of the Related Art

A conventional digital photographing apparatus filed by the present applicant in 2004 is disclosed in U.S. Patent Publication No. 119,876, “Method of Notification of Inadequate Picture Quality.” When in a reproducing mode, the digital photographing apparatus reproduces files from a storage medium.

Files stored in the storage medium are divided into two types: still-image and moving-image. In the reproducing mode, an image of a still-image file or an image of an initial frame of a moving-image file are displayed by a user. In a conventional digital photographing apparatus, loading a moving-image file and then finding an initial frame is required in order to display an image of the initial frame as a representative image of the moving-image file.

Therefore, it takes time to display the initial frame as the representative image of a moving-image file. In addition, errors may occur when finding an initial frame of a moving-image file and displaying the initial frame consecutively in response to file select signals consecutively generated by a user.

### SUMMARY OF THE INVENTION

The present invention provides a method of controlling a digital photographing apparatus for displaying a representative image of a moving-image file quickly and stably in a reproducing mode, and a digital photographing apparatus using the method.

According to an aspect of the present invention, there is provided a method of controlling a digital photographing apparatus in a moving-image photographing mode. The method includes creating a moving-image file in a storage medium, storing moving-image data in the moving-image file, and reproducing the moving-image data stored in the moving-image file when in a reproducing mode. The method also includes storing frame data of the moving-image data in the moving-image file as still-image data when in the moving-image photographing mode; and displaying a still image of the frame data stored in the moving-image file as a representative image of the moving-image file when in the reproducing mode.

In the method, an image of still-image data stored in advance in the moving-image photographing mode is displayed as the representative image of the moving-image file when in the reproducing mode. Further, loading the moving-image file and finding a set frame so as to display the representative image of the moving-image file are not required. Consequently, the representative image of the moving-image file can be displayed quickly and stably in the reproducing mode.

According to another aspect of the present invention, there is provided a digital photographing apparatus adopting the method.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view showing a digital photographing apparatus according to the present invention;

FIG. 2 is a back view showing the back of the digital photographing apparatus of FIG. 1;

FIG. 3 is a schematic diagram of the entire configuration of the digital photographing apparatus of FIG. 1;

FIG. 4 is a flow chart illustrating a main algorithm of a digital signal processor of FIG. 3;

FIG. 5 is a flow chart illustrating an algorithm of performing a preview mode of FIG. 4;

FIG. 6 is a flowchart illustrating an algorithm of performing a still-image photographing mode of FIG. 4;

FIG. 7 is a flowchart illustrating an algorithm of performing a moving-image photographing mode of FIG. 4;

FIG. 8 is a block diagram of the structure of a moving-image file obtained by performing the moving-image photographing mode of FIG. 4; and

FIG. 9 is a flowchart illustrating an algorithm of performing a reproducing mode of FIG. 4.

### DETAILED DESCRIPTION OF THE INVENTION

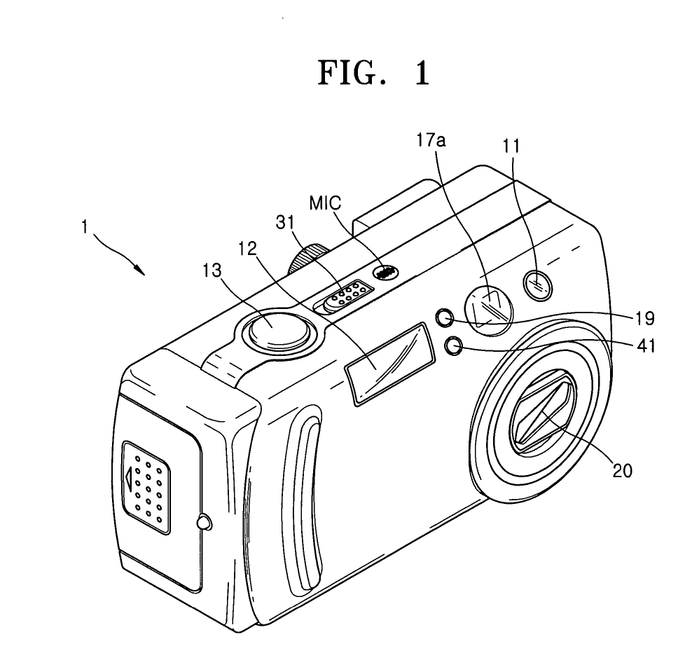

Referring to FIG. 1, the front part of a digital photographing apparatus 1 according to the present invention includes a microphone MIC, a self-timer lamp 11, a flash 12, a shutter release button 13, a viewfinder 17a, a flash light intensity sensor 19, a power switch 31, a lens unit 20, and a remote receiver 41.

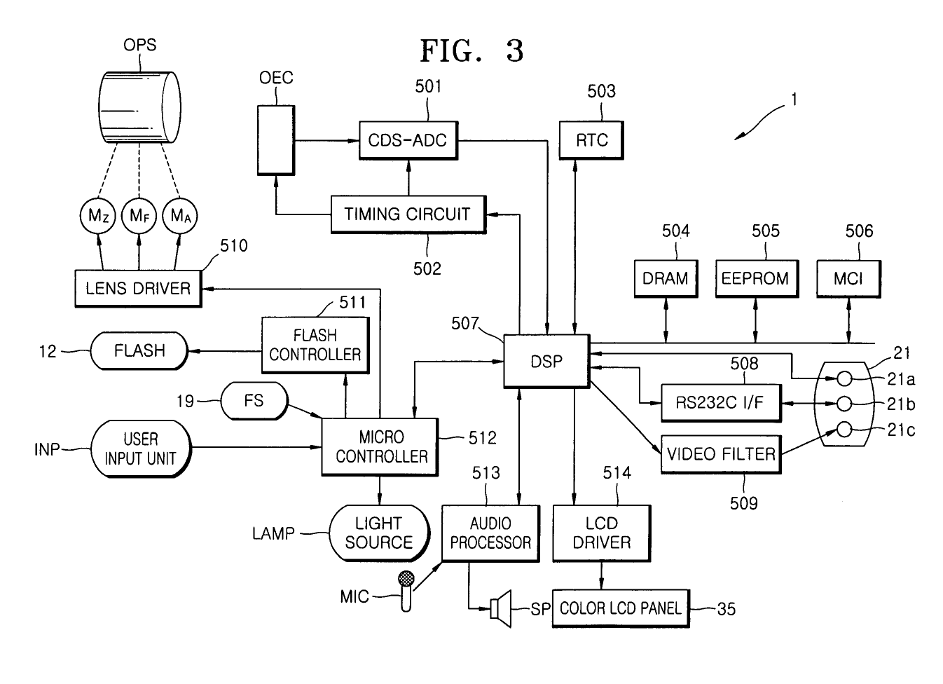

In a self-timer mode, the self-timer lamp 11 operates for a set period of time from when the shutter release button 13 is pressed to when an image starts to be captured. When the flash 12 operates, the flash light intensity sensor 19 senses the intensity of the light generated by the flash 12 and relays the sensed intensity of the light to a digital signal processor (DSP) 507 of FIG. 3 via a micro-controller 512 of FIG. 3. The remote receiver 41 receives command signals, for example, a photographing command signal, and relays the photographing command signal to the micro-controller 512.

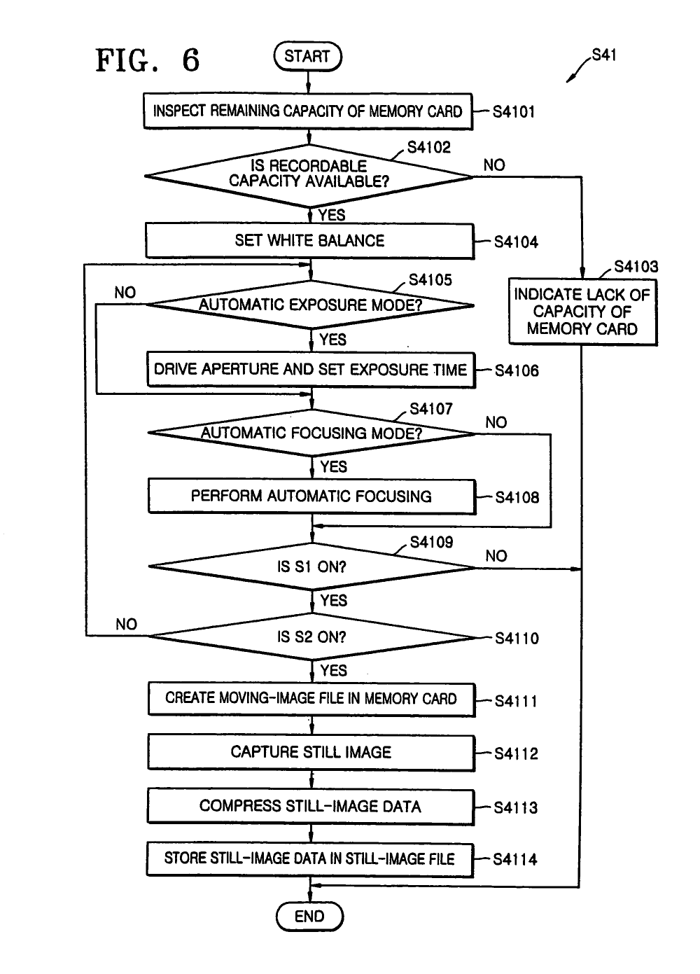

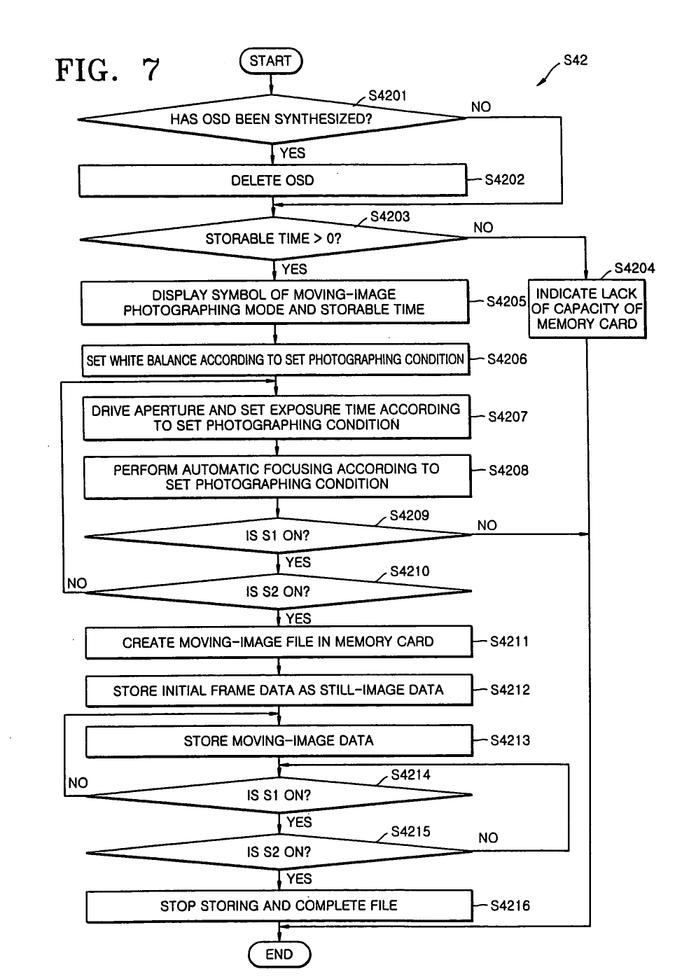

The shutter release button 13 has two levels. In other words, referring to FIGS. 6 and 7, after operating a wide angle-zoom button 39_{w} and a telephoto-zoom button 39_{T,} when a user lightly depresses the shutter release button 13 to a first level, a first level signal S1 from the shutter release button 13 is turned on. When the user fully depresses the shutter release button 13 to a second level, a second level signal S2 of the shutter release button 13 is turned on.

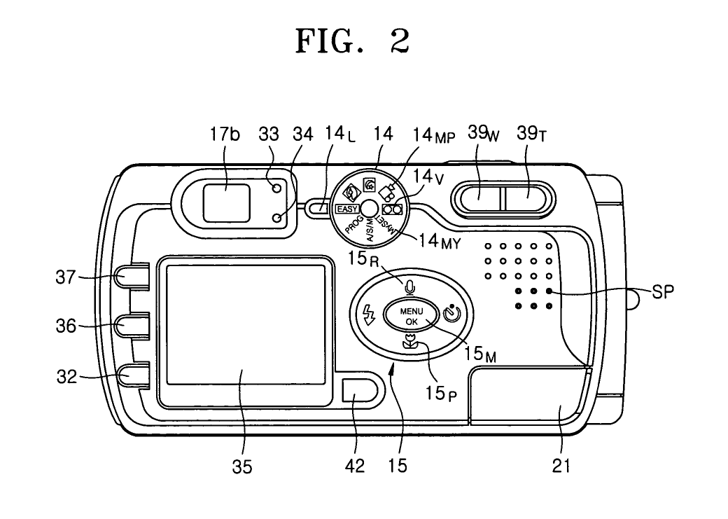

Referring to FIG. 2, the back of the digital camera 1 according to the present invention includes a mode dial 14, functional buttons 15, a manual focusing/deleting button 36, a manual adjusting/reproducing/terminating button 37, a reproducing mode button 42, a speaker SP, a monitor button 32, an automatic focusing lamp 33, a viewfinder 17b, a flash standby lamp 34, a color LCD panel 35, the wide angle-zoom button 39_{w}, the telephoto-zoom button 39_{T}, and an external interface unit 21.

The mode dial 14 is used for selecting any one of the operating modes of the digital camera 1 such as a simple photographing mode, a program photographing mode, a character photographing mode, a night view photographing mode, a manual photographing mode, a moving-image photographing mode 14_{MP}, a user setting mode 14_{MY}, and a recording mode 14_{V}.

After selecting the moving-image photographing mode 14_{MP}, when a user presses the shutter release button 13, a moving-image file is created in a storage medium, i.e., a memory card. The data of the initial frame, which is used to display a representative image, and moving-image data are stored in the moving-image file. When the user presses the shutter release button 13 again, the moving-image data being input stops being stored, and the moving-image file is set. The moving-image photographing mode 14_{MP} will be described in detail later with reference to FIG. 7.

The user setting mode 14_{MY} indicates an operating mode for specifying the photographic settings for a still-image or moving-image photographing mode. The recording mode 14_{V} is for recording only sounds, such as a user's voice. After selecting the recording mode 14_{V}, when a user presses the shutter release button, an audio file is created in the memory card and input audio data is stored in the audio file. When the user presses the shutter release button 13 again, the audio data stops being stored, and the audio file is set.

The functional buttons 15 are used for operating specific functions of the digital camera 1. The functional buttons 15 are also used as control buttons to manage the movement of an active cursor on the menu screen of the color LCD panel 35. For example, in the still mode or the moving-image photographing mode 14_{MP}, a user may set automatic proximity focusing by pressing a macro/move down button 15_{P}. Also, after selecting a specific option from a menu/select-confirm button 15_{M}, the macro/move-down button 15_{P} can be used to move the cursor down.

When a user presses a voice-memo/move-up button 15_{R}, a 10 second recording is possible upon consecutive photographing. Also, after selecting a specific option from the menu/select-confirm button 15_{M}, the voice-memo/move-up button 15_{R} can be used to move the cursor up. If the user presses the menu/select-confirm button 15_{M} when the active cursor is on a selection menu, the operation corresponding to the selection menu is performed.

The manual adjusting/reproducing/terminating button 37 is used for manual adjustment of specific conditions. In addition, when a user presses the manual adjusting/reproducing/terminating button 37, a selected moving-image file may be reproduced or its reproduction may be terminated.

The manual focusing/deleting button 36 is used for manual focusing or deleting in the photographing mode.

The monitor button 32 is used for controlling the operation of the color LCD panel 35. For example, in the photographing mode, when the user presses the monitor button 32, an image of a subject and photographing information are displayed on the color LCD panel 35. When the user presses the monitor button 32 again, the color LCD panel 35 is turned off. In the reproducing mode, when the user presses the monitor button 32 while an image file is being reproduced, photographing information about the image file is displayed on the color LCD panel 35. When the user presses the monitor button 32 again, only pure images are displayed.

The reproducing mode button 42 is used for switching between a reproducing mode and a preview mode.

The automatic focusing lamp 33 operates when a focus is well adjusted. The flash standby lamp 34 operates when the flash 12 of FIG. 1 is in a standby mode. A mode indicating lamp 14_{L} indicates a selection mode of the mode dial 14.

FIG. 3 is a schematic diagram of the entire configuration of the digital camera 1 of FIG. 1. The entire configuration and operation of the digital camera 1 of FIG. 1 will be described with reference to FIGS. 1 through 3 in the following.

An optical system (OPS) including the lens unit 20 and a filter unit optically processes light. The lens unit 20 of the OPS includes a zoom lens, a focus lens, and a compensation lens.

When the user presses the wide angle-zoom button 39_{w} or the telephoto-zoom button 39_{T} included in a user input unit (INP), a signal corresponding to the wide angle-zoom button 39_{w} or the telephoto-zoom button 39_{T} is relayed to the micro-controller 512. The micro-controller 512 controls a lens driver 510, thereby running a zoom motor M_{Z}, which, in turn, moves the zoom lens. In other words, when the user presses the wide angle-zoom button 39_{w}, the focal length of the zoom lens becomes short, thereby widening the angle of view. When the user presses the telephoto-zoom button 39_{T}, the focal length of the zoom lens becomes long, thereby narrowing the angle of view. Since the position of the focus lens is adjusted in a state where the position of the zoom lens is set, the angle of view is hardly affected by the position of the focus lens.

In the automatic focusing mode, a main controller built into the DSP 507 controls the lens driver 510 through the micro-controller 512, thereby driving a focus motor M_{F}. Accordingly, the focus lens is moved, and, in this process, the position of the focus lens, having the largest high frequency component of an image signal is set. This position may, for example, correlate to a certain number of driving steps of the focus motor M_{F}.

The compensation lens in the lens unit 20 of the OPS is not separately operated because the compensation lens compensates for the entire refractive index. A reference numeral M_{A} indicates a motor for driving an aperture (not shown).

An optical low pass filter included in the filter unit of the OPS eliminates high frequency optical noise. An infrared cut filter included in the filter unit of the OPS blocks the infrared component of incident light.

A photoelectric conversion unit (OEC) of a charge coupled device or a complementary metal oxide (CMOS) semiconductor converts light from the OPS into an analog electrical signal. Here, the DSP 507 controls a timing circuit 502 to control the operations of the OEC and a correlation-double-sampler-and-analog-to-digital converter (CDS-ADC) 501. The CDS-ADC 501 processes an analog signal from the OEC, eliminates high frequency noise, adjusts amplitude, and then converts the analog signal into a digital signal.

A real time clock (RTC) 503 provides time information to the DSP 507. The DSP 507 processes the digital signal from the CDS-ADC 501 and generates a digital image composed of luminance and chromaticity values.

A light source (LAMP) is operated by the micro-controller 512 in response to a control signal generated by the DSP 507 including the main controller. The light source (LAMP) includes the self-timer lamp 11, the automatic focusing lamp 33, the mode indicating lamp 14_{L}, and the flash standby lamp 34. The INP includes the shutter release button 13, the mode dial 14, the functional buttons 15, the monitor button 32, the manual focusing/deleting button 36, the manual adjusting/reproducing/terminating button 37, the wide angle-zoom button 39_{w}, and the telephoto-zoom button 39_{T}.

A dynamic random access memory (DRAM) 504 temporarily stores a digital image signal from the DSP 507. An electrically erasable and programmable read only memory (EEPROM) 505 stores algorithm and setting data. A user's memory card is inserted or removed in a memory card interface (MCI) 506. The digital image signal from the DSP 507 is input to an LCD driver 514, thereby displaying an image on the color LCD panel 35.

The digital image signal from the DSP 507 can be transmitted as serial communications via a universal serial bus (USB) connector 21a or via an RS232C interface 508 and an RS232C connector 21b. The digital image signal from the DSP 507 can also be transmitted as a video signal via a video filter 509 and a video output unit 21c. Here, the DSP 507 includes the main controller.

An audio processor 513 can relay sound from the microphone MIC to the DSP 507 or to speaker SP. In addition, the audio processor 513 can output an audio signal from the DSP 507 to the speaker SP. The micro-controller 512 controls the operation of a flash controller 511 in response to a signal from the flash light intensity sensor 19, thereby driving the flash 12.

A main algorithm of the DSP 507 of FIG. 3 will now be described with reference to FIGS. 1 through 4.

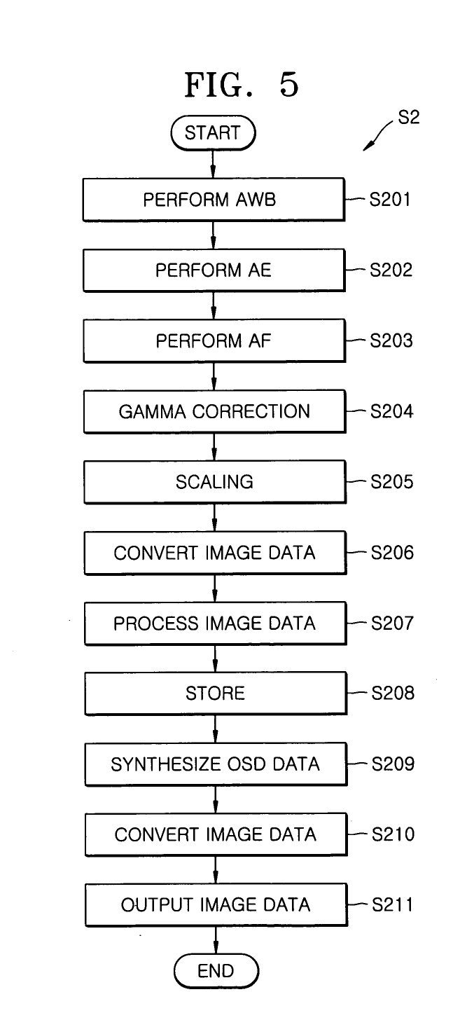

When power is applied to the digital photographing apparatus 1, the DSP 507 is initialized (S1). After the initialization (S1), the DSP 507 performs a preview mode (S2). In the preview mode, an image input is displayed on the display panel 35. An operation related to the preview mode will be described in detail later with reference to FIG. 5.

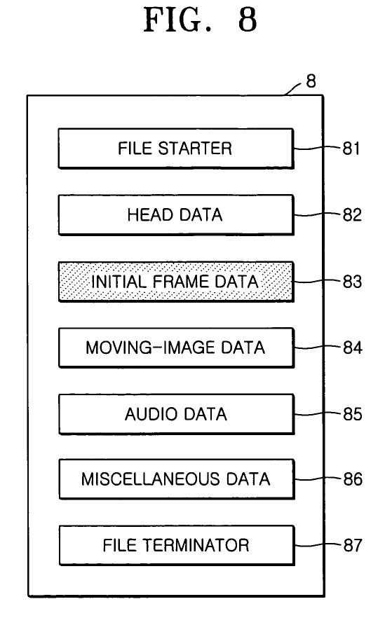

When the first level signal S1 from the shutter release button 13 is on after a user pressed the shutter release button 13 to the first level, the DSP 507 identifies a current operating mode (S3). Hereinafter, a description of the recording mode will be omitted. The DSP 507 performs the still-image photographing mode or the moving-image photographing mode depending on the chosen current operation mode (Steps S41 or S42). The still-image photographing mode (S41) algorithm will be described with reference to FIG. 6. The moving-image photographing mode (S42) algorithm will be described with reference to FIGS. 7 and 8.

When INP generated signals corresponding to a setting mode are input (S5), the setting mode, wherein an operating condition is set in response to the input signals from the INP, is performed (S6). In the next step (S7), it is determined whether a termination signal has been generated. When a termination signal is not generated, the DSP 507 continues to perform the following step.

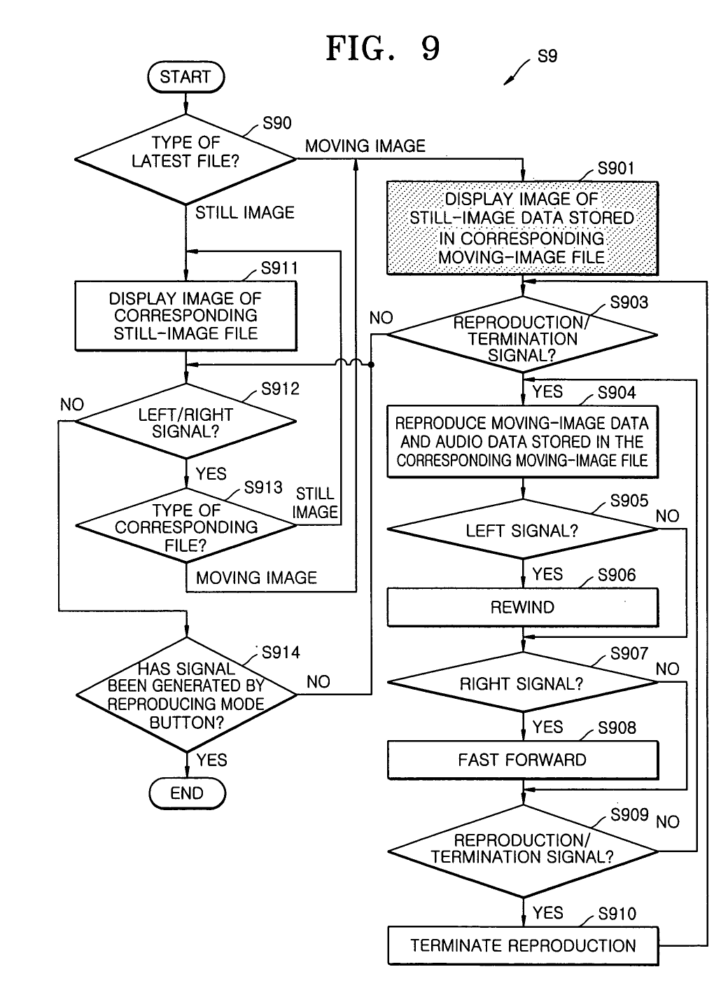

When a signal is generated by the reproducing mode button 42 in the INP (S8), a reproducing mode is performed (S9). In the reproducing mode, reproducing is performed in response to input signals from the INP. The reproducing mode (S9) algorithm will be described later with reference to FIG. 9. When the reproducing mode is terminated, the above steps are repeated.

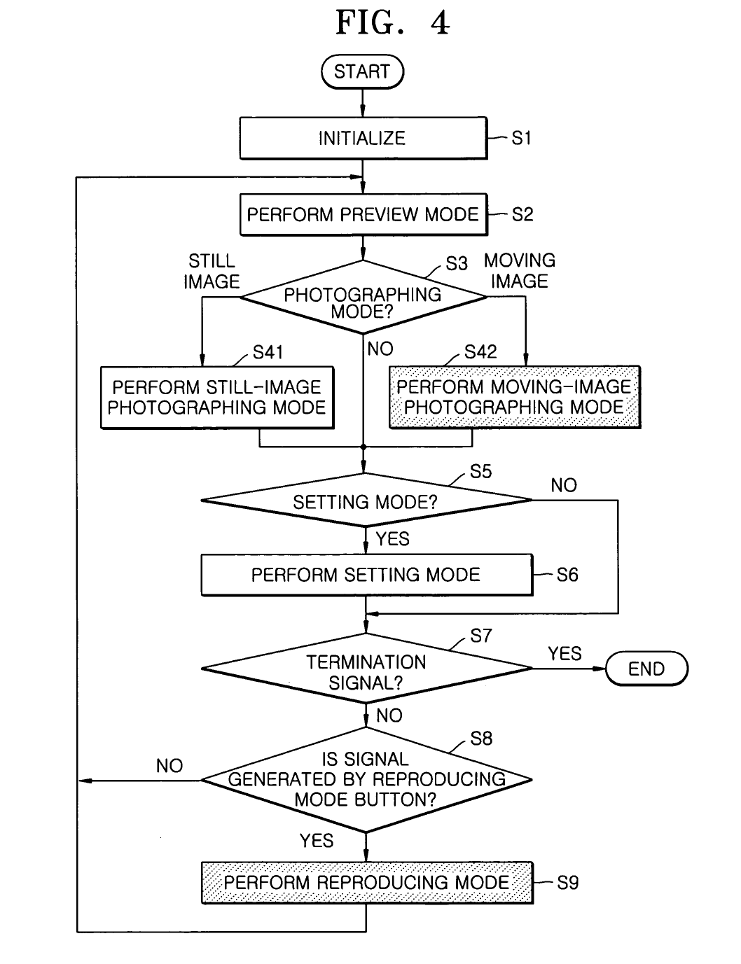

The preview mode (S2) algorithm of FIG. 4 will now be described with reference to FIGS. 1 through 3 and FIG. 5.

The DSP 507 performs automatic white balancing (AWB) and sets parameters related to the white balance (S201). In the automatic exposure mode (S202), the DSP 507 calculates the exposure by measuring incident luminance, drives the aperture driving motor M_{A} according to the calculated exposure, and sets a shutter speed (S203).

The DSP 507 performs gamma correction on input image data (S204) and scales the gamma corrected image data to meet display standards (S205). The DSP 507 converts the scaled input image data from an RGB (red, green, and blue) format into a luminance-chromaticity format (S206). The DSP 507 processes the input image data depending on resolution and display location and also filters the input image data (S207).

The DSP 507 temporarily stores the input image data in the DRAM 504 of FIG. 3 (S208). The DSP 507 synthesizes the data temporarily stored in the DRAM 504 of FIG. 3 and on-screen display (OSD) data (S209). The DSP 507 converts the synthesized image data from the RGB format into the luminance-chromaticity format (S210) and outputs the image data in the converted format via the LCD driver 514 of FIG. 3 (S211).

FIG. 6 illustrates an algorithm of performing the still-image photographing mode of FIG. 4 (S41). The still-image photographing mode (S41) algorithm will now be described with reference to FIGS. 1 through 3 and FIG. 6. Here, the present position of the zoom lens is already set.

The DSP 507 inspects the remaining capacity of the memory card (S4101) and determines whether the memory card has enough capacity to store a digital image signal (S4102). If the memory card does not have enough storage capacity, the DSP 507 indicates the lack of capacity of the memory card and ends the still-image photographing mode (S4103). If the memory card has enough storage capacity, the following steps are performed.

The DSP 507 sets white balance and parameters related to the white balance according to a present photographing condition (S4104). In the automatic exposure mode (S4105), the DSP 507 calculates the exposure by measuring incident luminance, drives the aperture driving motor M_{A} according to the calculated exposure, and sets the exposure time (S4106). In the automatic focusing mode (S4107), the DSP 507 performs automatic focusing and drives the focus lens (S4108).

When the first level signal S1 from the shutter release button 13 is on (S4109), the DSP 507 continues to perform the following steps.

The DSP 507 identifies whether the second level signal S2 is on (S4110). When the second level signal S2 is not on, it means that the user did not press the shutter release button 13 to the second level to take a photograph. Then, the DSP 507 repeats Steps S4105 through S4110.

When the second level signal S2 is on, it means that the user pressed the shutter release button 13 to the second level and the DSP 507 creates a still-image file in the memory card (S4111). Next, the DSP 507 captures a still image (S4112). In other words, the DSP 507 receives still-image data from the CDS-ADC 501 and the DSP 507 compresses the received still-image data (S4113). The DSP 507 stores the compressed still-image data in the still-image file (S4114).

FIG. 7 is a flowchart illustrating the moving-image photographing mode (S42) algorithm of FIG. 4. The moving-image photographing mode algorithm will now be described with reference to FIGS. 1 through 3 and FIG. 7.

If an on-screen display (OSD) has been synthesized with image data being output, the DSP 507 deletes the OSD data (S4201 and S4202).

The DSP 507 inspects the remaining capacity of the memory card and determines whether storable time for storing digital moving-image data is present (S4203). When the memory card does not have enough storage capacity, the DSP 507 indicates the lack of capacity of the memory card (S4204). When the memory card has enough storage capacity, the following steps are performed.

The DSP 507 displays a symbol of the moving-image photographing mode and storable time on the LCD panel 35 (S4205).

The DSP 507 sets a white balance and parameters related to the white balance according to a set photographing condition (S4206). Then, the DSP 507 performs the automatic exposure mode according to the set photographing condition (S4207). In other words, the DSP 507 calculates the exposure by measuring incident luminance, drives the aperture driving motor M_{A} according to the calculated exposure, and sets exposure time. The DSP 507 also performs automatic focusing according to the set photographing condition and drives the focus lens (S4208).

When the first level signal S1 from the shutter release button 13 is on (S4209), the DSP performs the following steps.

The DSP 507 determines whether the second level signal S2 is on (S4210). When the second level signal S2 is not on, it means that the user did not press the shutter release button 13 to the second level to take a photograph. Therefore, the DSP 507 repeats Steps 4207 through 4210.

When the second level signal S2 is on, it means that the user pressed the shutter release button 13 to the second level. Accordingly, the DSP 507 creates a moving-image file in the memory card (S4211). Next, the DSP 507 stores the initial frame data within the moving-image data from the CDS-ADC 501 in the moving-image file as still-image data (S4212).

The DSP 507 compresses the moving-image data from the CDS-ADC 501 using a motion picture experts group (MPEG) compressing algorithm or a motion joint photographic experts group (MJPEG) compressing algorithm and stores the compressed data in the moving-image file (S4213).

During this process, if both the first level signal S1 and the second level signal S2 from the shutter release button 13 are on, the DSP 507 stops storing the moving-image data and sets the moving-image file (Steps S4214 through S4216).

Referring to FIG. 8, a moving-image file 8 obtained by performing the moving-image photographing mode (S42) includes a file starter 81, head data 82, initial frame data 83, moving-image data 84, audio data 85, miscellaneous data 86, and a file terminator 87. The file starter 81 includes data signifying the start of the file. The head data 82 includes information about the file format.

The initial frame data 83 is still-image data stored by performing S4212 of FIG. 7 and displayed as a representative image of the moving-image file 8 in the reproducing mode (S9 of FIG. 4). Therefore, it is not required to find a set frame after loading the moving-image file 8 in order to display a representative image of the moving-image file 8. Consequently, a representative image of the moving-image file 8 can be displayed quickly and stably in the reproducing mode (S9 of FIG. 4).

The initial frame data 83 is a joint photographic experts group (JEPG) thumbnail file with resolution of 320×240 pixels. Therefore, the initial frame data 83 may have a file name such as “temp. jpg.”

The audio data 85 corresponding to the moving-image data 84 is stored in the same moving-image file 8. The miscellaneous data 86 may include user defined subtitle data at a user's choice. The file terminator 87 includes data signifying file termination.

The reproducing mode (S9) algorithm of FIG. 4 will be described in the following with reference to FIGS. 1 through 3 and FIGS. 8 and 9.

The DSP 507 identifies the type of a latest file created in the memory card (S90). If the type of the latest file created in the memory card is a still image, the DSP 507 transmits data of the still-image file to the LCD driver 514. Accordingly, the LCD panel 35 displays the still-image (S911).

After S911, if a left or right signal is not generated by a move-left or move-right functional button 15 (S912), but a signal is generated by the reproducing mode button 42 (S914), the DSP 507 terminates the reproducing mode (S9).

After S911, if the left or right signal is generated by the move-left or move-right functional button 15 (S912), the DSP 507 identifies the type of a file corresponding to the generated signal (S913).

In S913, if the type of the file is a still image, the DSP 507 performs S911 and following steps. On the other hand, in S90 and S913, if the type of the file is a moving-image, the DSP 507 performs the following steps.

The DSP 507 transmits the still-image data 83 stored in the moving-image file 8 to the LCD driver 514. Accordingly, the color LCD panel 35 displays an image of an initial frame of the moving-image file 8 as a representative image of the moving-image file 8 (S901). In this case, since data of the representative image is stored in advance in the moving-image photographing mode and displayed in the reproducing mode, it is not required to load the moving-image file 8 and find a set frame so as to display the representative image of the moving-image file 8. Therefore, in S901, the representative image of the moving-image file 8 can be displayed quickly and stably.

While the representative image is displayed, if a reproduction/termination signal is not generated after a user pressed the manual adjusting/reproducing/terminating button 37 (S903), the DSP 507 performs S912 and following steps.

While the representative image is displayed, if the user presses the manual adjusting/reproducing/terminating button 37 (S903), thus generating the reproduction/termination signal, the DSP 507 performs the following steps.

The moving-image data 84 and the audio data 85 stored in the moving-image file 8 are transmitted to the LCD driver 514 and the audio processor 513, respectively, and reproduced (S904).

If the left signal is generated by the move-left button (S905), the DSP 507 performs rewind (S906). Similarly, if the right signal is generated by the move-right button (S907), the DSP 507 performs fast-forward (S908).

If the reproduction/termination signal is not generated after a user pressed the manual-adjusting/reproducing/terminating button 37 (S909), the DSP 507 performs S904 and following steps.

If the reproduction/termination signal is generated after the user pressed the manual-adjusting/reproducing/terminating button 37 (S909), the DSP 507 terminates the reproduction (S910) and performs S903 and following steps.

The reproducing mode algorithm of FIG. 9 is designed to display an image of a single still-image file or a single moving-image file on the color LCD panel 35 of FIG. 2. However, the reproducing mode algorithm of FIG. 9 can be used to display a plurality of thumbnail images on the LCD panel 35. In other words, when the thumbnail images are displayed on the color LCD panel 35, an image of still-image data stored in the moving-image file is displayed. Similarly, a thumbnail image of the moving-image file is displayed. Here, an algorithm of selecting and reproducing a thumbnail image is identical to the algorithm of performing the reproducing mode (described previously with reference to FIG. 9).

As described above, in a method of controlling a digital photographing apparatus and a digital photographing apparatus using the same according to the present invention, an image of a still-image file, stored in advance in a moving-image photographing mode, is displayed in a reproducing mode as a representative image. Therefore, it is not required to load a corresponding moving-image file and find a set frame so as to display the representative image of the moving-image file. Consequently, the representative image can be displayed quickly and stably in the reproducing mode.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of processing moving-image data in a digital photographing apparatus, the digital photographing apparatus having at least a moving-image photographing mode and a reproducing mode, the method comprising:
when the apparatus is in the moving-image photographing mode,
inputting moving-image data into the apparatus;
creating a moving-image file in a storage medium;
storing moving-image data in the moving-image file; and
storing frame data of the moving-image data in the moving-image file as still-image data;
when the apparatus is in the reproducing mode,
displaying a still image of the frame data stored in the moving-image file as a representative image of the moving-image file; and
reproducing the moving-image data stored in the moving-image file.

2. The method of claim 1, wherein the apparatus is in the moving-image photographing mode, and wherein initial frame data of the moving-image data is stored in the moving-image file as the still-image data.

3. The method of claim 1, wherein the apparatus is in the reproducing mode, and wherein, while the representative image is displayed, the moving-image data is reproduced in response to a reproduction command signal generated by a user.

4. The method of claim 3, wherein the apparatus is in the reproducing mode, and wherein, while the moving-image data is being reproduced, portions of the moving-image data are replayed or skipped in response to a command signal generated by a user during playback of the moving-image data.

5. The method of claim 1, further comprising:
storing, in the moving image file, audio data corresponding to the moving-image data in the moving image file.

6. The method of claim 3, wherein, when the apparatus in the reproducing mode, audio data corresponding to the moving-image data is reproduced.

7. The method of claim 1, wherein the frame data stored in the moving-image file is data of a file compressed according to a still-image compressing algorithm.

8. The method of claim 1, wherein the moving-image file comprises a file starter, head data, still-image frame data, and a file terminator.

9. The method of claim 8, wherein the moving image file further comprises audio data corresponding to the moving-image data.

10. The method of claim 1, further comprising:
determining the remaining capacity of the recording medium.

11. The method of claim 10, further comprising:
determining whether the remaining capacity of the recording medium is sufficient for recording.

12. A digital photographing apparatus comprising a digital signal processor, wherein the digital signal processor performs steps comprising:
when the apparatus is in the moving-image photographing mode,
inputting moving-image data into the apparatus;
creating a moving-image file in a storage medium;
storing moving-image data in the moving-image file; and
storing frame data of the moving-image data in the moving-image file as still-image data;
when the apparatus is in the reproducing mode,
displaying a still image of the frame data stored in the moving-image file as a representative image of the moving-image file; and
reproducing the moving-image data stored in the moving-image file.

13. The digital photographing apparatus of claim 12, wherein the moving-image file comprises a file starter, head data, still-image frame data, and a file terminator.

14. The digital photographing apparatus of claim 12, wherein the still-image frame data is initial frame data.

15. The digital photographing apparatus of claim 12, wherein the digital signal processor, while in the reproducing mode, performs further steps comprising reproducing the moving-image data in response to a reproduction command signal generated by a user.

16. The digital photographing apparatus of claim 15, wherein the apparatus is in the reproducing mode, and wherein, while the moving-image data is being reproduced, portions of the moving-image data are replayed or skipped in response to a command signal generated by a user during playback of the moving-image data.

17. A digital photographing apparatus comprising:
means for creating a moving-image file in a storage medium;
means for storing moving-image data in the moving-image file;
means for storing frame data of the moving-image data in the moving-image file as still-image data;
means for displaying a still image of the frame data stored in the moving-image file as a representative image of the moving-image file; and
means for reproducing the moving-image data stored in the moving-image file means for inputting and processing light.

18. The digital photographing apparatus of claim 17, wherein the creating means comprises means for defining a file starter, head data, still-image frame data, and a file terminator.

19. The digital photographing apparatus of claim 17, further comprising means for reproducing the moving-image data in response to a reproduction command signal generated by a user.

20. The digital photographing apparatus of claim 17, further comprising means for replaying or skipping portions of the moving-image data in response to a command signal generated by a user during playback of the moving-image data.
